(19) United States
(12) Patent Application Publication
(10) Pub. No.: US 2014/0157607 A1
(43) Pub. Date: Jun. 12, 2014

(54) DISPOSABLE PLASTIC KNIVES WITH SERRATED CUTTING EDGE

(71) Applicant: David B. McFarland, Rainbow City, AL (US)

(72) Inventor: David B. McFarland, Rainbow City, AL (US)

(21) Appl. No.: 14/171,763

(22) Filed: Feb. 3, 2014

Related U.S. Application Data
(60) Provisional application No. 61/732,844, filed on Dec. 3, 2012.

(51) Int. Cl. B26B 9/02

(52) U.S. Cl. CPC B26B 9/02
USPC 30/355

(57) ABSTRACT

A plastic knife is provided comprising a handle, a blade, and a cutting edge. The blade may include a first surface and an opposite second surface, and integrally formed with and extending longitudinally from the handle. The cutting edge may be formed along one edge of the blade, the cutting edge comprising: (a) a first plurality of teeth integrally connected to and extending from the first surface, each tooth in the first plurality of teeth separated by a first concave groove; and (b) a second plurality of teeth integrally connected to and extending from the second surface, each tooth in the second plurality of teeth separated by a second concave groove. The first plurality of teeth and the second plurality of teeth may be integrally formed together while teeth in the first plurality of teeth and teeth in the second plurality of teeth are offset by a distance.

### CLAIM OF PRIORITY UNDER 35 U.S.C. §119

The present Application for Patent claims priority to U.S. Provisional Application No. 61/732,844 entitled “Disposable Plastic Knives”, filed Dec. 3, 2012, which is hereby expressly incorporated by reference herein.

### FIELD

Various embodiments of the invention pertain to plastic or disposable cutlery, and more particularly, to disposable plastic knives having a serrated edged.

### BACKGROUND

Plastic knives are widely used around the world for disposable use. Such disposable use include the use outdoors, such as for camping and barbeques, at fast-food restaurants and on airplanes. In addition to the benefits of being disposable, plastic knives may be preferable for use over metal knives or other cutlery for weight and safety reasons.

However, despite the widespread use of disposable plastic knives, there are many problems inherent with conventional disposable plastic knives. First, conventional disposable plastic knives are not designed to cut (tear) food equally well when the knife is stroked forward or backward. Second, conventional disposable plastic knives fail to have stacking edges that mate properly regardless of the shape of the profile of the knives.

In view of the above, what is needed are disposable plastic knives designed to cut (tear) food equally well when the knife is stroked forward or backward. Furthermore, disposable plastic knives are needed that have stacking edges that mate properly regardless of the shape of the profile of the knives allowing for optimization of the handle of the knives by making it strong and lighter in weight.

### SUMMARY

The following presents a simplified summary of one or more implementations in order to provide a basic understanding of some implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

According to a first example, a plastic knife is provided comprising a handle, a blade, and a cutting edge. The blade may include a first surface and an opposite second surface, and integrally formed with and extending longitudinally from the handle. The cutting edge may be formed along one edge of the blade, the cutting edge comprising: (a) a first plurality of teeth integrally connected to and extending from the first surface, each tooth in the first plurality of teeth separated by a first concave groove; and (b) a second plurality of teeth integrally connected to and extending from the second surface, each tooth in the second plurality of teeth separated by a second concave groove. The first plurality of teeth and the second plurality of teeth may be integrally formed together while teeth in the first plurality of teeth and teeth in the second plurality of teeth are offset by a distance.

### BRIEF DESCRIPTION OF THE DRAWINGS

The features, nature, and advantages of the present aspects may become more apparent from the detailed description set forth below when taken in conjunction with the drawings in which like reference characters identify correspondingly throughout.

FIG. 1 illustrates a partial side plan view of a plastic knife, according to one example.

FIG. 2 illustrates a close up angular view of the serrated teeth of the knife of FIG. 1.

FIG. 3 illustrates a close up view of the serrated teeth of the knife of FIG. 1.

FIG. 4 illustrates a cross sectional view of the serrated teeth of the knife of FIG. 2.

FIG. 5 illustrates a close up angular view of serrated teeth of a plastic knife, according to one example.

FIG. 6 illustrates a close up view of serrated teeth of the plastic knife of FIG. 5.

FIG. 7 illustrates a cross-section view of stacked knives, according to one example.

### DETAILED DESCRIPTION

In the following description numerous specific details are set forth in order to provide a thorough understanding of the invention. However, one skilled in the art would recognize that the invention might be practiced without these specific details. In other instances, well known methods, procedures, and/or components have not been described in detail so as not to unnecessarily obscure aspects of the invention.

### Overview

A first feature provides a disposable plastic knife having a serrated edge. The serrated edge may include a first row of teeth on a first side of a knife blade and a second row of teeth on an opposite second side of the knife blade, where the teeth in the first row and second row are offset from each other.

A second feature provides a disposable plastic knife having a serrated edge with different sized teeth on each side of a blade. The serrated edge may include a first row of teeth on a first side of a knife blade and a second row of teeth on an opposite second side of the knife blade. The teeth in the first row may be of a first width while the teeth on the second side of the blade may be of a second width.

Plastic Knife with Serrated Cutting Teeth

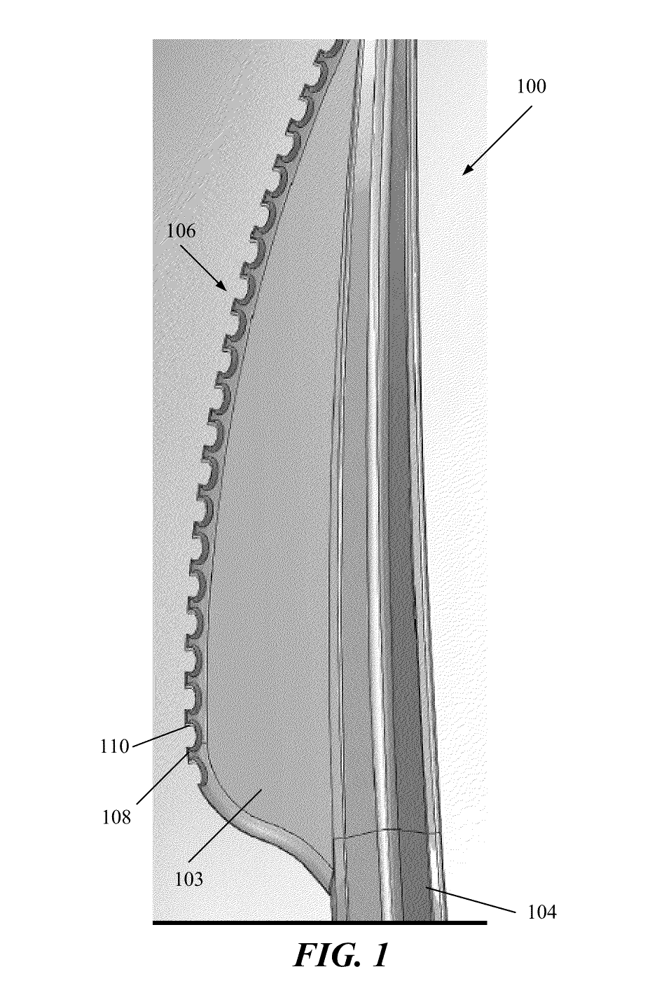

FIG. 1 illustrates a partial side plan view of a plastic knife 100 according to one example. In one example, the plastic knife 100 may be made from a polystyrene material.

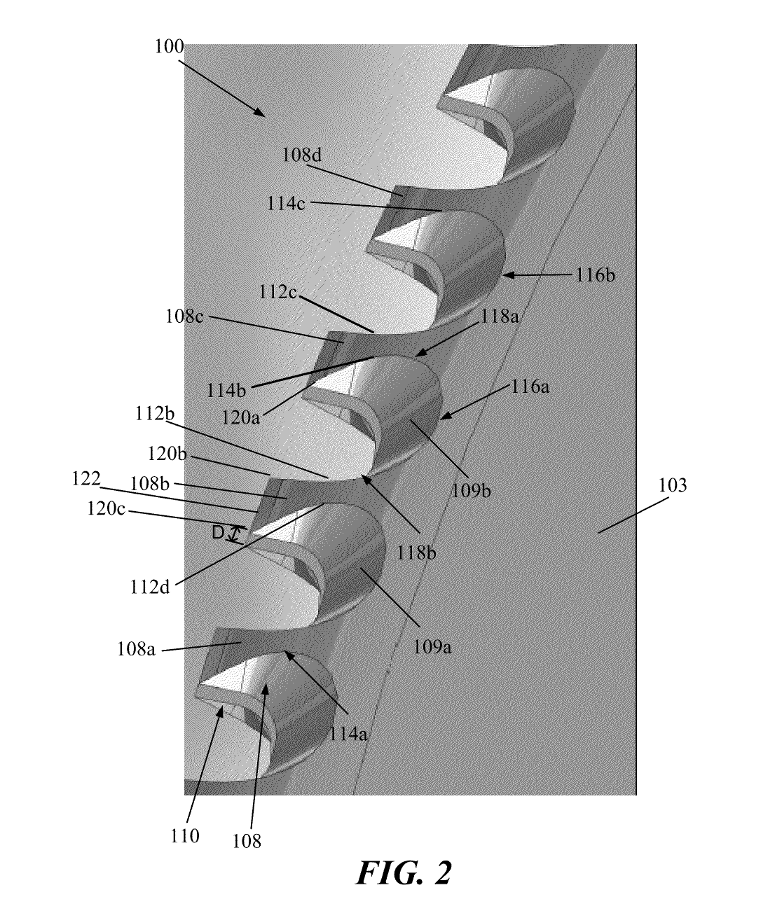

FIG. 2 illustrates a close up angular view of the serrated teeth of the knife 100 of FIG. 1.

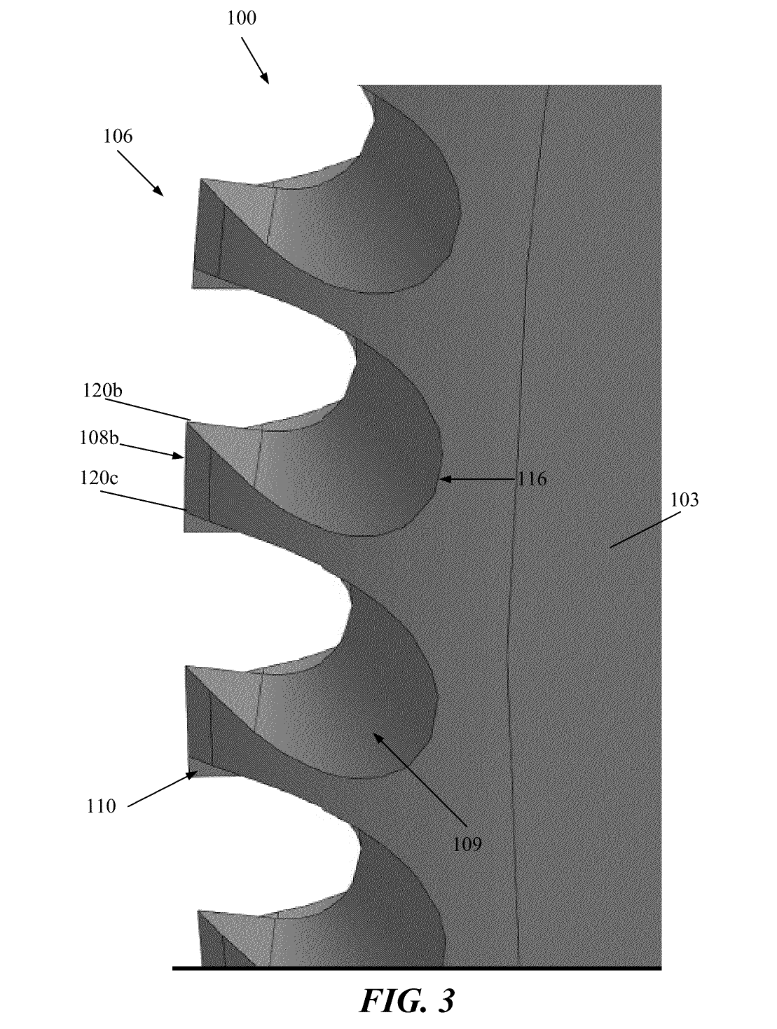

FIG. 3 illustrates a close up view of the serrated teeth of the knife 100 of FIG. 1.

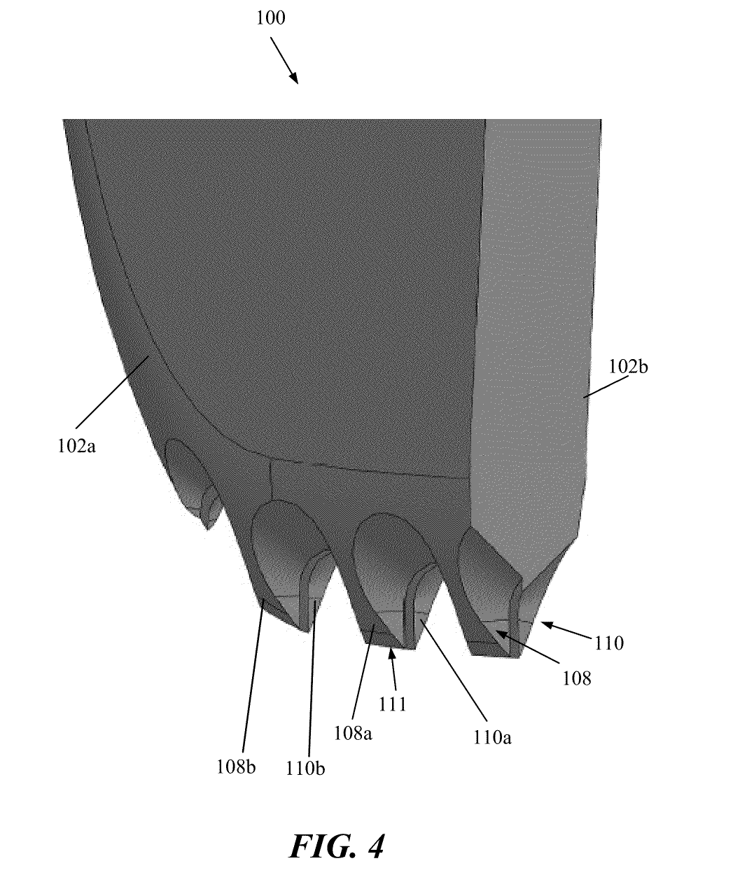

FIG. 4 illustrates a cross sectional view of the serrated teeth of the knife 100 of FIG. 2.

The plastic knife 100 (FIGS. 1-4) may be molded from a plastic material and include a blade 103, having a first surface 102a and a second surface 102b, integrally formed with a handle 104. The blade 103 may extend longitudinally from the handle 104 and include a cutting edge 106 extending downwardly from the blade 103. The cutting edge 106 may comprise a first plurality of teeth 108 integrally connected to and extending downwardly from the first surface 102a of the blade 103 and a second plurality of teeth 110 integrally connected to and extending downwardly from the second surface 102b of the blade 103.

Each tooth in the first plurality of teeth 108 (108a, 108b, 108c, 108d) may be separated by a concave groove 109 (109a, 109b) and comprise a first side 112 and a second side 114 having arcuate or curved shapes. As shown, the first side 112 and the second side 114 may be a minor image of each other and integrally connected to adjacent concave grooves 109. That is, a first side 112c of one tooth 108c may be integrally connected to a concave groove and a second side 114b of the tooth is connected to a different, adjacent concave groove. Such concave grooves 109 may be defined between adjacent teeth 108. Additionally, as illustrated in FIG. 4, each composite knife tooth 111 may comprise a first tooth segment 108a (on the first surface/side 102a of the blade 103) and a second tooth segment 110a (on the second surface/side 102b of the blade 103).

As shown, for example, the second side 114b of a first tooth 108c may be formed together with the first side 112b of a second tooth 108b at a first or top point 116a of a first concave groove 109b. From the first or top point 116a, the second side 114b of the first tooth 108c extends outwardly to a second or middle point 118a and then extends inwardly to a third or end point 120a. Similarly, from the first or top point 116a, the first side 112b of the second tooth 108b extends outwardly to a fourth or middle point 118b and then extends inwardly to a fifth or end point 120b. In this manner, the first concave groove 109b is defined. In one example, the concave groove 109b may be a scalloped cut design.

A cutting portion 122 of the tooth 108b may extend between a first end point 120b of the second side 112b of the first tooth 108b and a second end point 120c of the second side 112d of the first tooth 108b.

Similarly, although not shown in detail, each tooth in the second plurality of teeth 110 may be a mirror image of each tooth in the first plurality of teeth 108, separated by a concave groove and comprise a first side and a second side having arcuate or curved shapes. The first side and the second side may be a mirror image of each other and integrally connected to adjacent concave grooves. That is, the first side of one tooth is integrally connected to a concave groove and the second side of the tooth is connected to a different, adjacent concave groove.

Although the teeth in the first plurality of teeth 108 may be a mirror image of the teeth in the second plurality of teeth 110 and integrally formed together, the teeth in the first plurality of teeth 108 and the teeth in the second plurality of teeth 110 may be offset by a distance D. For instance, the distance D may be 0.25 mm. Offsetting the teeth between the two different surfaces 102a and 102b may form a sharp point with a complex cutting edge that runs approximately vertical and by design has the ability to cut (tear) food equally well when the knife is stroked forward or backward. Although such an offset would be difficult if not extremely expensive to accomplish in steel, as it would require tiny cutting tools on a computer numerical control (CNC) machine and would take a long time to do on an expensive piece of machinery, creating such an offset may be easily and cost effectively molded in plastic. Additionally, the cutting teeth may have negative rake which is good for use in plastic because plastic knives cannot really cut like a steel knife (e.g., due to lack of hardness) they can only tear through the food.

Plastic Knife with Serrated Cutting Teeth of Different Widths

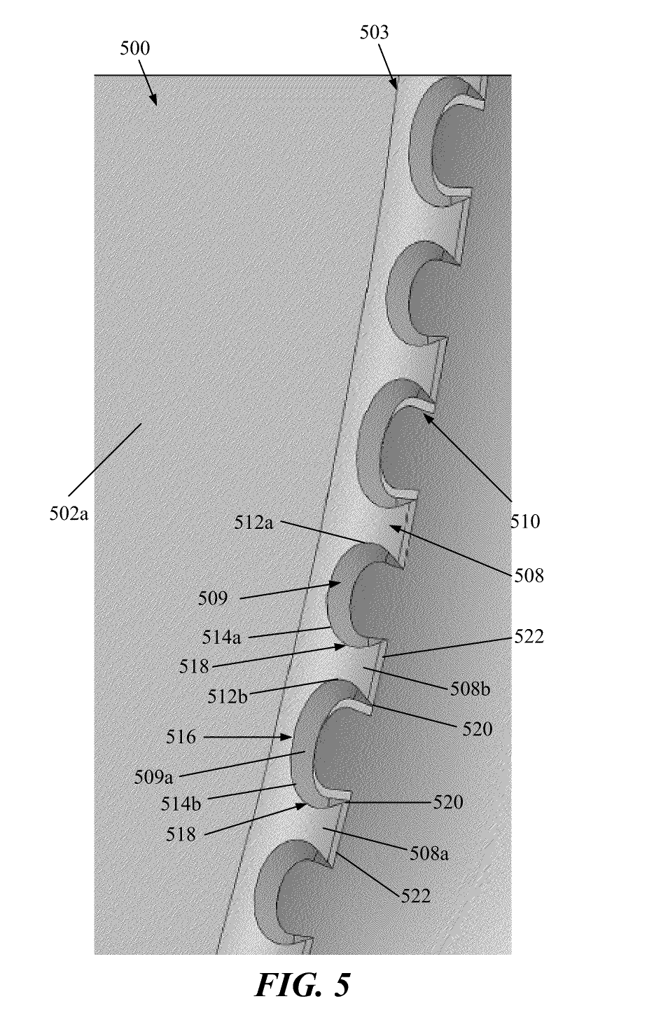

FIG. 5 illustrates a close up angular view of serrated teeth of a plastic knife, according to one example.

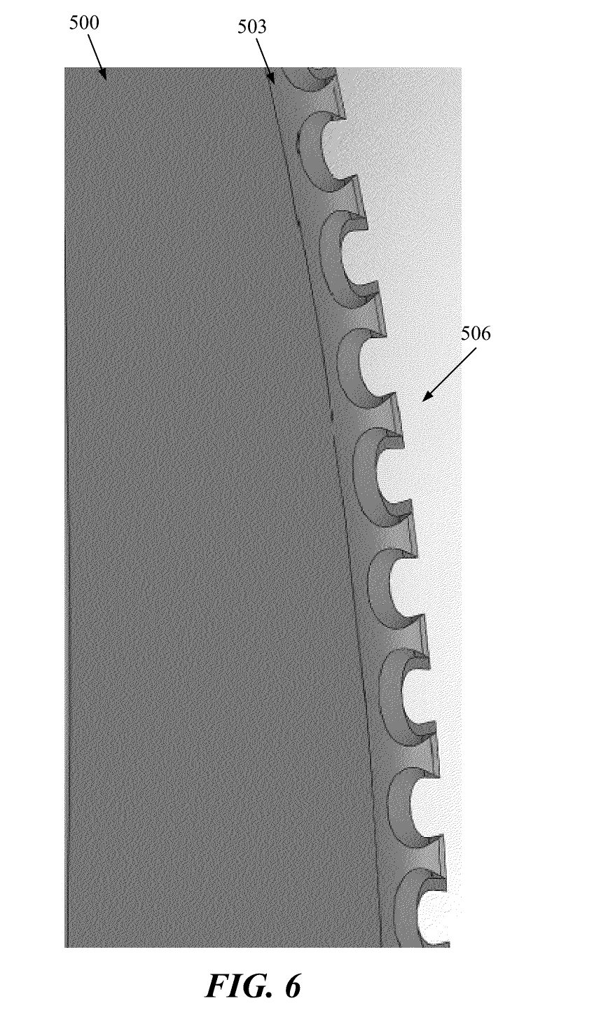

FIG. 6 illustrates a close up view of serrated teeth of the plastic knife of FIG. 5.

The plastic knife 500 may be molded from a plastic material and include a blade 503, having a first surface 502a and an opposite second surface (not shown), integrally formed with a handle. The blade 503 may extend longitudinally from the handle and include a cutting edge 506 extending downwardly from the blade 503. The cutting edge 506 may comprise a first plurality of teeth 508 integrally connected to and extending downwardly from the first surface 502a of the blade 503 and a second plurality of teeth 510 integrally connected to and extending downwardly from the second surface of the blade 503.

Each tooth in the first plurality of teeth 508 may be separated by a concave groove 509 and comprise a first side 512 and a second side 514 having an arcuate or curved shape. As shown, the first side 512 and the second side 514 may be a minor image of each other and integrally connected to adjacent concave grooves 509. That is, the first side of one tooth is integrally connected to a concave groove and the second side of the tooth is connected to a different, adjacent concave groove.

As shown, for example, the second side 514b of a first tooth 508a is formed together with the first side 512b of a second tooth 508b at a first or top point 516 of a first concave groove 509a. From the first or top point 516, both the second side 514b of the first tooth 508a and the first side 512b of the second tooth 508b extend outwardly to a second or middle point 518 and then extend inwardly to a third or end point 520 forming a convex shape and the first concave groove 509a. A cutting portion 522 may extend between the end points 520 of the second side 514b of the first tooth 508a and the first side 512b of the second tooth 508b.

Similarly, although not shown in detail, each tooth in the second plurality of teeth 510 may have the same shape of each tooth in the first plurality of teeth 508, separated by a concave groove and comprise a first side and a second side having an arcuate or curved shape. The first side and the second side may be a mirror image of each other and integrally connected to adjacent concave grooves. That is, the first side of one tooth is integrally connected to a concave groove and the second side of the tooth is connected to a different, adjacent concave groove.

Although the teeth in the first plurality of teeth 508 may be the same shape of the teeth in the second plurality of teeth 510 and integrally formed together, the teeth in the first plurality of teeth 508 and the teeth in the second plurality of teeth 510 may be of different sizes. That is, the teeth in the first plurality of teeth 508 may have first width and the teeth in the second plurality of teeth 510 may have a second width, where the first width is different than the second width. According to one embodiment, the first width may be greater than the second width. Alternatively, the second width may be greater than the first width.

As shown in FIG. 5, the second width is greater than the first width such that the teeth in the first plurality of teeth 508 are smaller than the teeth in the second plurality of teeth 510. When the first plurality of teeth 508 and the second plurality of teeth 510 are integrally connected, a pair of offsets located within a shared concave groove, the shared concave groove includes a first tooth side and a second tooth side. Additionally, the offsets alternate between concave grooves in the cutting edge. That is, a concave groove having offsets may be adjacent to and located between a pair of concave grooves without offsets.

As discussed above, offsetting the teeth may form a sharp point with a complex cutting edge that runs approximately vertical and by design will have the ability to cut (tear) food equally well when the knife is stroked forward or backward. Although such an offset would be difficult if not extremely expensive to accomplish in steel, as it would require tiny cutting tools on a CNC machine and would take a long time to do on an expensive piece of machinery, creating such an offset can be easily and cost effectively molded in plastic. Additionally, the cutting teeth may have negative rake which is good for use in plastic because plastic knives cannot really cut like a steel knife (due to lack of hardness) they can only tear through the food.

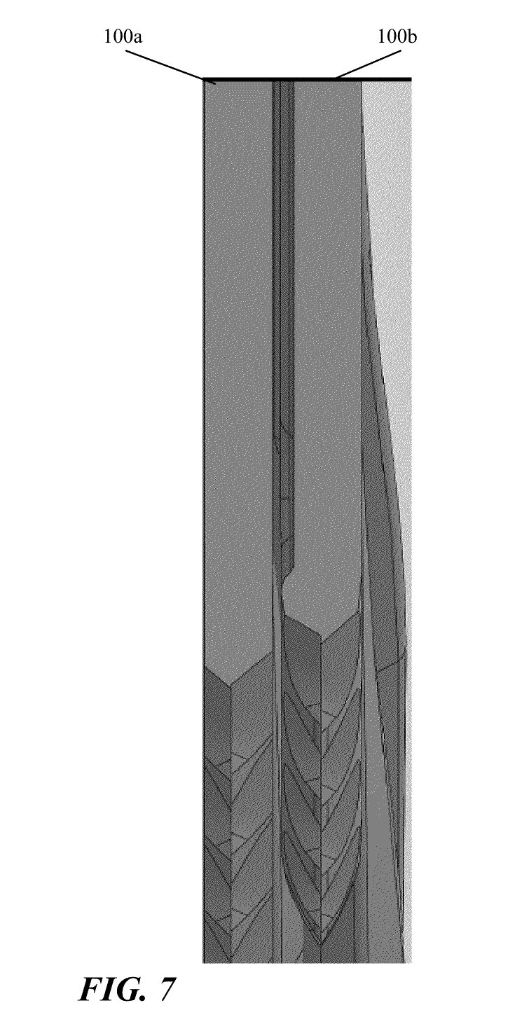

FIG. 7 illustrates a cross-section view of stacked knives, according to one example.

One or more of the components and functions illustrated in the previous figures may be rearranged and/or combined into a single component or embodied in several components without departing from the invention. Additional elements or components may also be added without departing from the invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications are possible. Those skilled, in the art will appreciate that various adaptations and modifications of the just described preferred embodiment can be configured without departing from the scope and spirit of the invention. Therefore, it is to be understood that, within the scope of the appended claims, the invention may be practiced other than as specifically described herein.

What is claimed is:

1. A plastic knife, comprising:
a handle;
a blade including a first surface and an opposite second surface, and integrally formed with and extending longitudinally from the handle; and
a cutting edge formed along one edge of the blade, the cutting edge comprising:
a first plurality of teeth integrally connected to and extending from the first surface, each tooth in the first plurality of teeth separated by a first concave groove; and
a second plurality of teeth integrally connected to and extending from the second surface, each tooth in the second plurality of teeth separated by a second concave groove;
wherein the first plurality of teeth and the second plurality of teeth are integrally formed together; and
wherein teeth in the first plurality of teeth and teeth in the second plurality of teeth are offset by a distance.

2. The plastic knife of claim 1, wherein the distance is 0.25 mm or less.

3. The plastic knife of claim 1, wherein the teeth in the first plurality of teeth are a mirror image of the teeth in the second plurality of teeth.

4. The plastic knife of claim 1, wherein offsetting the teeth in the first plurality of teeth and the teeth in the second plurality of teeth form a sharp point with a complex vertical cutting edge for cutting an object equally well when the knife is stroked forward or backward.

5. The plastic knife of claim 1, wherein each tooth in the first plurality of teeth is separated by a first side concave groove and each tooth in the second plurality of teeth is separated by a second side concave groove.

6. The plastic knife of claim 5, wherein the each tooth in the first plurality of teeth comprises:
a first side having a first side upper end and a first side bottom end, the first side upper end integrally connected to a first concave groove;
a second side having a second side upper end and a second side bottom end, the second side upper end integrally connected to a second concave groove; and
a cutting edge portion integrally connected between the first side bottom end and the second side bottom end.

7. The plastic knife of claim 6, wherein the first and second sides have an acruate shape.

8. The plastic knife of claim 6, wherein the first concave groove is adjacent to the second concave groove.

9. The plastic knife of claim 8, wherein the first side is a minor image of the second side.

10. The plastic knife of claim 1, wherein the teeth in the first plurality of teeth are the same width as the teeth in the second plurality of teeth.

11. The plastic knife of claim 1, wherein the teeth in the first plurality of teeth have a first width and the teeth in the second plurality of teeth have a second width; and wherein the first width is different than the second width.

12. The plastic knife of claim 11, wherein integrally forming the teeth in the first plurality of teeth with the teeth in the second plurality of teeth creates a pair of offsets located within a shared concave groove, the shared concave groove includes a first tooth side and a second tooth side.

13. The plastic knife of claim 12, wherein each alternating concave groove in the cutting edge includes the pair of offsets.
